(19) United States
(12) Patent Application Publication
(10) Pub. No.: US 2013/0009458 A1
(43) Pub. Date: Jan. 10, 2013

(54) Track guide

(76) Inventor: John Robert Neary, Kentville (CA)

(21) Appl. No.: 12/800,115

(22) Filed: May 10, 2010

(51) Int. Cl. B62D 55/18; B62D 55/24

(52) U.S. Cl. 305/195

(57) ABSTRACT

This invention describes a track guide, used with endless tracks mounted over tires of off-road vehicles, preventing laterally rolling off the inner or outer surfaces of the drive tires. The track guide counteracts, grips and controls the lateral slippage of the endless track dislodging from the drive tires, caused by conditions such as tensioned forces, sharp power-on turns in snow, ice, mud, sand and all other situations. The track guide effectively improves the ride and maneuverability of off road vehicles.

### BACKGROUND OF THE INVENTION

Endless tracks are commonly installed over the tires of lightweight skid-steer all terrain vehicles or other off road vehicles to improve their operation over soft ground, cut over land, in snow, mud, and all other conditions. Conventional endless tracks either consist of a flexible rubber track material with separated track guides bolted on each track section or they are a plurality of integrated moulded plastic track guide and endless track sections, that are pinned together to form an endless track.

This invention deals with flexible rubber track material with separated track guides bolted on each track section.

A current manufacturer of both metal and moulded plastic separated track guides intended to keep tires in alignment on an endless track is a Numbered Company 9127-1585 Quebec Inc. of St. Philippe de Neri, Quebec, (phone # 418-856-1508). The guides are provided with a continuous inside curved profile from the base to the top of the track guide.

The use of these types of track guides have proven troublesome, in that the tires will climb laterally resulting in roll off and lateral track dislodgment. This particularly occurs when softer tires and/or tracks are lightly tensioned.

Tru-Trax™ of Isanti, Minn. (www.trutrax.com) is another endless track manufacturer. Unlike the above mentioned prior art, the endless track comprises a plurality of integrated moulded plastic track guides and endless track sections that are pinned together. These combined moulded sections also have a track guide with a continuous inside curved profile from the base to the top. As in the prior art mentioned above, similar operational defects, such as roll off and lateral track dislodgments, occur when using these types of combined moulded track guides and endless track sections. In addition, they are heavier in weight and have less traction.

When the above types of current endless tracks are installed tightly on more stiffly constructed tires they will less frequently detach their grip with fewer roll off situations. Adversely, the increased track tension creates a higher axle bearing load requiring more engine power, and increases bearing wear and track noise. In addition, stiffer tires and tightly installed tracks provide a stiff and uncomfortable ride.

### SUMMARY OF THE INVENTION

The objective of this invention is a track guide used in combination with a less tensioned track operating on a variety of types of tires that frictionally and functionally grips and controls the lateral slippage of the tracks dislodging from the tires on off road vehicles.

The allowance and use of softer tires effectively improves the ride and performance of off road vehicles.

Furthermore, it decreases wear on axle bearings, load on engine power and track noise.

The track's functional operation also improves in snow, heavy mud, sand and all other conditions.

### DESCRIPTION OF THE DRAWINGS

Although the characteristic features of the invention will be particularly pointed out in the claims, the invention itself and the manner in which it may be made and used may be better understood by referring to the following description and accompanying drawings, where like reference numerals refer to like parts throughout the several views of the drawings in which

FIG. 1 is a side view of the track guide;

FIG. 2 shows a plurality of track guides in their assembled environment;

FIG. 3 is a cross-sectional view taken along line X-X; and

FIG. 4 is a perspective view of the track guide

### DESCRIPTION OF THE PREFERRED EMBODIMENT

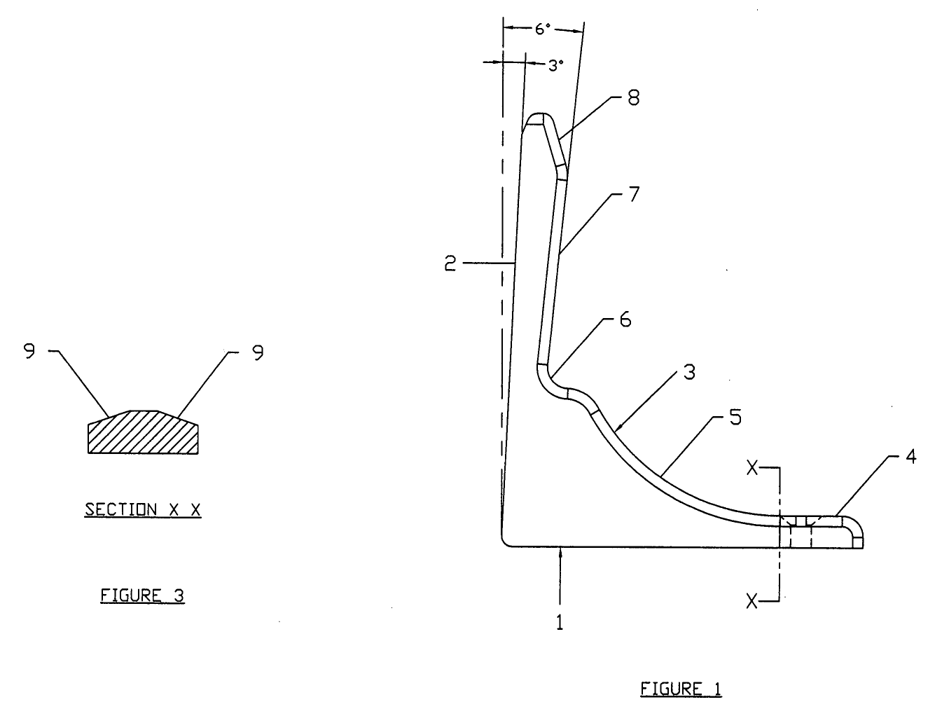

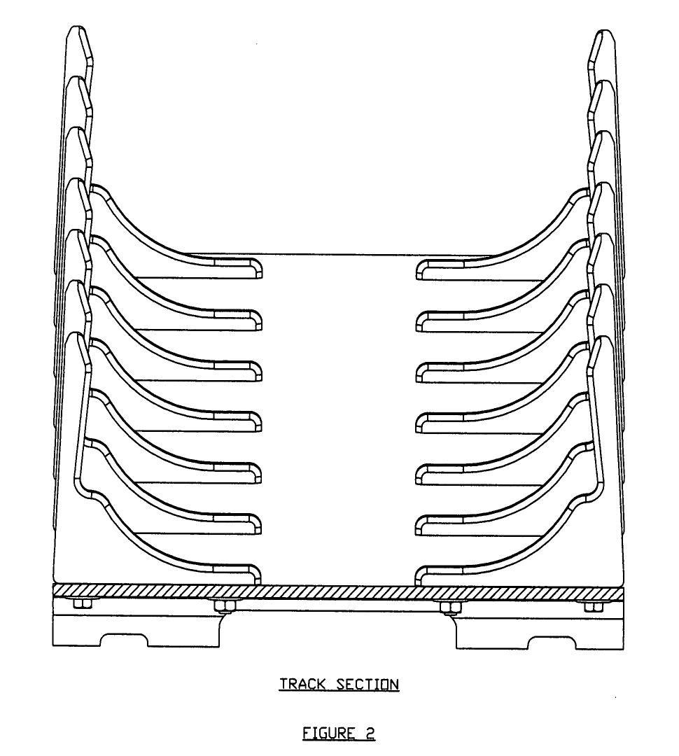

The accompanying drawings, as described above, illustrate a preferred embodiment of a track guide used in conjunction with an endless track. The following disclosure describes a preferred embodiment of the track guide. Reference from FIGS. 1 and 2, a track guide 1, made of ridged material having in general an outer L shaped profile, the base of the L shape, serves for purposes to fasten the said base section to the outer and inner edges of an endless track (shown in FIG. 2). The vertical outer section of the L shape 2, has an inward slope of approximately three degrees from the vertical. The inner profile 3, of the L shape has a short horizontal base section 4, extending into an upwardly curved radius section 5. The said upwardly curved radius section 5, follows the radius profile of a conventional tire. The curved radius section 5, is followed by a smaller radius notch area 6. Following the notch area 6, is an abruptly upward and inward extending section 7, this section is approximately six degrees from the vertical. Finally, at the upper area of the inner profile, is an outward slanted and rounded section 8, that extends and meets at the apex of the vertical section of the outer L shaped profile 2.

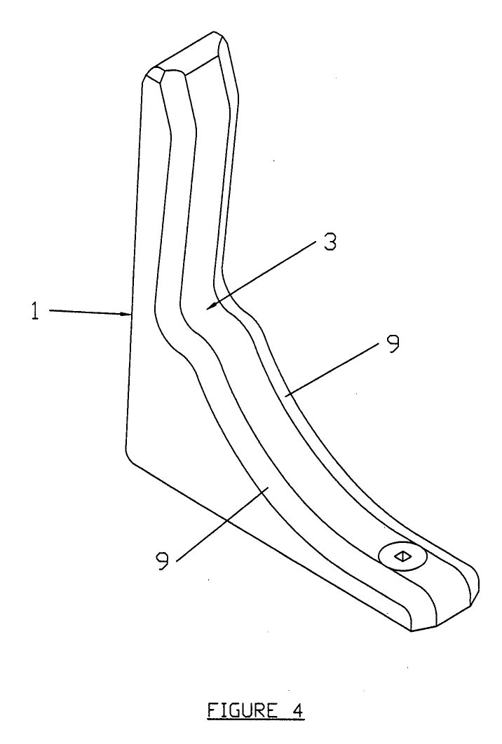

The slanted and rounded section 8, serves to direct the tires as they approach and pass the surface of the track guide. All the edges located on the inner profile 3 are beveled (9) as shown in FIGS. 3 and 4.

The notch area 6, and the inward angled section 7, serve to frictionally and functionally grip the radius profile and side wall of the tires and prevent them from climbing the guides when the tires bear against them.

In a second embodiment, the said track guide design can be integrated into a moulded segment, many of which can be pinned together to form a track.

I claim:

1. A track guide that prevents slippage and roll-off of an endless track when lateral forces are applied to drive or steering tires, wherein said track guide having a general outer L shaped profile, the base of which serves for fastening to the inner surface of an endless track section, and the vertical outer section of said L shape profile has an inward slope of approximately three degrees from the vertical; the inner profile, of the L shape comprises a horizontal base section, an extending upwardly curved radius section; which corresponds to the radius and shoulder tread of a conventional tire; a small-radius notch area, and a further upwardly and inwardly extending area of approximately six degrees from the vertical that serves to frictionally and functionally grip lateral tire forces; an outward slanted section that meets the apex of said outer L shaped profile, serves to direct the tires as they approach and pass the surface of the track guide.

2. As claimed in claim 1, the said track design can be integrated into a moulded segment, many of which can be pinned together to form a track.
